(19) United States
(12) Patent Application Publication
(10) Pub. No.: US 2014/0270529 A1
(43) Pub. Date: Sep. 18, 2014

(54) ELECTRONIC DEVICE, METHOD, AND STORAGE MEDIUM

(71) Applicant: KABUSHIKI KAISHA TOSHIBA, Tokyo (JP)

(72) Inventor: Chikashi Sugiura, Hamura-shi (JP)

(73) Assignee: KABUSHIKI KAISHA TOSHIBA, Tokyo (JP)

(21) Appl. No.: 14/252,603

(22) Filed: Apr. 14, 2014

Related U.S. Application Data
(63) Continuation of application No. PCT/JP2013/057699, filed on Mar. 18, 2013.

(51) Int. Cl. G06F 3/0488

(52) U.S. Cl. CPC G06F 3/04883
USPC 382/189

(57) ABSTRACT

According to one embodiment, an electronic device includes an input controller and a processor. The input controller is configured to receive stroke data. The processor is configured to, when a first stroke data and a second stroke data input after the first stroke data at least partially overlap with each other, edit the first stroke data by using the second stroke data.

### CROSS REFERENCE TO RELATED APPLICATIONS

This application is a Continuation Application of PCT Application No. PCT/JP2013/057699, filed Mar. 18, 2013, the entire contents of which are incorporated herein by reference.

### FIELD

Embodiments described herein relate generally to a process of handwriting.

### BACKGROUND

In recent years, various electronic devices such as tablet computers, PDAs, and smartphones have been developed. In general, such electronic devices include a touchscreen display to ease an input operation by a user.

A user touches a menu or an object displayed on the touchscreen display with his finger or the like to instruct the electronic device to execute a function associated with the menu or the object. Furthermore, the user writes a letter, figure, and diagram with his finger or stylus on the touchscreen display to create handwriting including a plurality of strokes.

However, in most cases, a conventional electronic device with a touchscreen display is realized as a consumer product specialized for controlling various media data such as images, music, and the like. That is, such a conventional electronic device may not necessarily be suitable for business use where written information must be dealt with, namely, a business conference, business negotiations, and product development setting, etc. When inputting the written information to a device, a hardware keyboard operation is more practical in comparison with a handwriting input operation. For this reason, using paper notebook to record written information is still the mainstream in business settings.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of an example of an exterior of an electronic device of one of the embodiment.

FIG. 2 illustrates an example of handwriting written on a touchscreen display of the electronic device of the embodiment.

FIG. 3 is a view to explain stroke data (handwriting page data) corresponding to the handwriting of FIG. 2.

FIG. 4 illustrates an example of a system structure of the electronic device of the embodiment.

FIG. 5 is a block diagram of an example of functional structure of a handwriting notebook application program executed by the electronic device of the embodiment.

FIG. 6 illustrates an example of a flow of a handwriting input process executed by the electronic device of the embodiment.

FIG. 7 illustrates an example of details of a preprocessing of handwriting input process and a character recognition process shown in FIG. 6.

FIG. 8A illustrates an example of a stroke in an inclusion state which is an example of the overwritten correction.

FIG. 8B illustrates another example of a stroke in the inclusion state which is an example of the overwritten correction.

FIG. 8C illustrates still another example of a stroke in the inclusion state which is an example of the overwritten correction.

FIG. 8D illustrates still another example of a stroke in the inclusion state which is an example of the overwritten correction.

FIG. 9A illustrates a principle of determination of the inclusion state of stroke.

FIG. 9B illustrates the principle of determination of the inclusion state of stroke.

FIG. 9C illustrates the principle of determination of the inclusion state of stroke.

FIG. 9D illustrates the principle of determination of the inclusion state of stroke.

FIG. 10A illustrates an example of a repeated stroke which is an example of the overwritten correction.

FIG. 10B illustrates another example of the repeated stroke which is an example of the overwritten correction.

FIG. 10C illustrates still another example of the repeated stroke which is an example of the overwritten correction.

FIG. 11A illustrates an example of a stroke in a connection state which is an example of the overwritten correction.

FIG. 11B illustrates another example of the stroke in the connection state which is an example of the overwritten correction.

FIG. 11C illustrates another example of the stroke in the connection state which is an example of the overwritten correction.

FIG. 11D illustrates still another example of the stroke in the connection state which is an example of the overwritten correction.

FIG. 11E illustrates still another example of the stroke in the connection state which is an example of the overwritten correction.

### DETAILED DESCRIPTION

Various embodiments will be described hereinafter with reference to the accompanying drawings.

In general, according to one embodiment, an electronic device includes an input controller and a processor. The input controller is configured to receive stroke data. The processor is configured to, if a first stroke data and a second stroke data input after the first stroke data at least partially overlap with each other, edit the first stroke data by using the second stroke data.

FIG. 1 is a perspective view of an example of an exterior of an electronic device of one of the embodiments. The electronic device is, for example, a stylus-based portable electronic device including an input part configured to receive a handwriting input of information written with a stylus or a finger. The electronic device stores a handwriting input on the input part as one or more stroke data items indicative of time series of coordinates of sampling points of characters, numerals, symbols, and diagrams in the written information or a handwriting locus of a diagram, not as bitmap image data. Furthermore, the electronic device retrieves the handwriting based on the stroke data (or, the retrieval process may be performed in a server system 2, and only a result thereof is displayed in the electronic device). Furthermore, the electronic device performs a character recognition process of an input stroke data group (stroke data corresponding to one character, numeral, or symbol region), and stores handwriting as a text of character code for retrieving the handwriting layer based on the text (as with the above, the recognition process may be performed in the server system 2). Furthermore, instead of the character recognition based on the stroke data, an OCR process to perform the character recognition by bitmap-imaging of the input stroke data group.

The electronic device may be realized as a tablet computer, notebook computer, smartphone, personal digital assistant (PDA), and the like. Hereinafter, the description is presented given that the electronic device is realized as a tablet computer 10. The tablet computer 10 is a portable electronic device which is often referred to as a tablet or slate computer, and includes a main body 11 and a touchscreen display 17 configured to receive a handwriting input.

The main body 11 includes a thin box-shaped casing. In the touchscreen display 17, a flat panel display and a sensor configured to detect a point of contact of a stylus or finger on the flat panel display are integrated. The flat panel display may be, for example, a liquid-crystal display device (LCD). The sensor may be, for example, an electrostatic capacitance touchpanel or electromagnetic induction digitizer. The following description is presented given that both digitizer and touchpanel are integrated in the touchscreen display 17 as sensors.

Both digitizer and touchpanel are arranged to cover a screen of the flat panel display. The touchscreen display 17 may detect not only a touch operation on the screen with a user's finger but also a touch operation on the screen with a stylus 100. The stylus 100 may be, for example, an electromagnetic induction stylus. A user uses an external object (stylus 100 or finger) to perform a handwriting input operation on the touchscreen display 17. During the handwriting input operation, a motion trail of the external object (stylus 100 or finger) moving on the screen, that is, a locus of stroke (handwriting) handwritten by the handwriting input operation is depicted in real time, and each locus of stroke is displayed on the screen. The motion trail of the external object between a time of contacting and a time of rising from the screen is counted as a single stroke. A set of multiple handwritten strokes corresponding to handwritten letters, numerals, or figures defines handwriting, or, a set of figures defines handwriting.

The handwriting is stored in a storage medium as time series information indicative of a coordinate string of a locus of each stroke and a sequential relationship between strokes. The time series information is described below in detail with reference to FIGS. 2 and 3. The time series information indicates an order of handwriting of a plurality of strokes and includes a plurality of stroke data items corresponding to the plurality of strokes. In other words, the time series information stands for a set of time series stroke data items corresponding to each of the plurality of strokes. Each stroke data item corresponds to a particular stroke and includes the coordinate data series (time series coordinates) corresponding to each point on the stroke locus. The sequence of the plurality of stroke data items corresponds to a sequence of handwriting of each stroke, that is, a stroke order.

The tablet computer 10 reads any optional time series information from the storage medium and displays the handwriting corresponding to the time series information, that is, loci corresponding to each of the strokes indicated based on the time series information on the screen. Furthermore, the tablet computer 10 includes an edit function. With the edit function, the user can perform an edit operation using an “eraser” tool, range selection tool, and various other tools to erase or remove any optional stroke or handwritten letter in the handwriting currently being displayed. The edit function includes cancelling some of the handwriting operations previously made. Furthermore, the edit function includes adding any optional handwritten letter of symbol in the handwriting currently being displayed.

In the embodiment, the aforementioned time series information (handwriting) may be managed as a single page or a plurality of pages. Here, the time series information may be divided into several items by an area unit to fit in a single screen, and a group of the items of the time series information fit in the single screen may be stored as a single page. Or, a size of the page may be set variable. When the page size is variable, it can be expanded to have an area larger than the size of a single screen, and thus, handwriting having an area larger than the screen size can be handled as a single page. When the whole page cannot be displayed in a single frame at the same time, the page size may be reduced to display the whole page or a displayed part of the page may be moved by vertical and horizontal scrolls.

Since the time series information can be managed as a page data, the term “time series information” hereinafter may be referred to as “handwriting page data”, or more simply, “handwriting data”.

The tablet computer 10 has a network communication function to work in conjunction with other personal computers or the server system 2 on the internet. That is, the tablet computer 10 includes a wireless communication device such as wireless LAN, and executes wireless communication with the other personal computers. Furthermore, the tablet computer 10 can execute communication with the server system 2 on the internet. The server system 2 is a system configured to share various information and execute online storage service or other various cloud computing services. The server system 2 may be achieved with one or more server computer.

The server system 2 includes a mass storage device such as a hard disk drive (HDD). The tablet computer 10 transmits the time series information (handwriting page data) to the personal computer 1 via a network to store the time series information (handwriting) in the storage device of the server system 2 (upload). To secure the communication between the tablet computer 10 and the server system 2, the server system 2 may authorize the tablet computer 10 when initiating the communication. Here, a dialog box may be displayed on a screen of the tablet computer 10 to prompt the user to input an ID or password, or the ID of the tablet computer 10 may be transferred to the server system 2 automatically from the tablet computer 10.

Thereby, the tablet computer 10 can handle a number of time series information items (handwritten page data) or mass time series information (handwriting page data) even when the volume of the built-in storage of the tablet computer 10 is low.

Furthermore, the tablet computer 10 reads any optional one or more handwriting stored in the storage medium of the server system 2 (download), and displays each locus of the strokes depicted by the read handwriting on a screen of the display 17 of the tablet computer 10. Here, a collection of thumbnails (thumbnail images) of reduced-size pages of each of the plurality of the time series information may be displayed on the screen of the display 17, or a single page selected from the thumbnails may be displayed on the screen of the display 17 in a normal size.

As can be understood from the above, the storage medium used in the embodiments to store the time series information can be either one of the storage of the tablet computer 10 and the storage of the server system 2. The user of the tablet computer 10 can store any optional time series information in either one of the storage of the tablet computer 10 or of the server system 2.

Now, with reference to FIGS. 2 and 3, a relationship between the stroke (of character, numeral, symbol, diagram, or table) handwritten by the user and the time series information is described. FIG. 2 illustrates an example of handwriting (handwritten character string) handwritten on the touchscreen display 17 with the stylus 100 and the like.

During a handwriting operation, there is often a case where a character or a figure is written first, and then a different character or figure is written thereupon. In FIG. 2, a handwritten character string of “ABC” is written first in this order, and a handwritten symbol of “↓” is then put near the handwritten character “A”.

The handwritten character “A” is represented by two strokes (“Λ” and “-”) written using the stylus 100 and the like, that is, by two handwriting loci. The handwriting locus “Λ” which is initially written with the stylus 100 is sampled in real-time at, for example, certain time intervals. Thus, time series coordinates SD11, SD12, . . . SD1n of the stroke “Λ” can be obtained. Similarly, the handwriting locus “-” which is written next with the stylus 100 is sampled in real-time at certain time intervals and thus, time series coordinates SD21, SD22, . . . SD2n of the stroke “-” can be obtained.

The handwritten character “B” is represented by two strokes handwritten with the stylus 100 and the like, that is, by two handwriting loci. The handwritten character “C” is represented by a single stroke handwritten with the stylus 100 and the like, that is, by a single handwriting locus. The handwritten arrow “↓” is represented by two strokes handwritten with the stylus 100 and the like, that is, by two handwriting loci.

FIG. 3 shows the time series information (handwriting page data) 200 corresponding to the handwriting of FIG. 2. The time series information includes a plurality of stroke data items SD1, SD2, . . . SD7. In the time series information 200, stroke data items SD1, SD2, . . . SD7 are arranged in stroke order, that is, the chronological order of writing.

In the time series information 200, each of the first and second stroke data items SD1 and SD2 represents the two strokes of the handwritten character “A”. Each of the third and fourth stroke data items SD3 and SD4 represents the two strokes of the handwritten character “B”. The fifth stroke data item SD5 represents the stroke of the handwritten character “C”. Each of the sixth and seventh stroke data items SD6 and SD7 represents the two strokes of the handwritten symbol “↓”.

Each stroke data item includes a coordinate data series (time series coordinate) corresponding to a single stroke. In other words, each stroke data item includes a plurality of coordinates corresponding to a plurality of points on the locus of the single stroke. In each stroke data item, the coordinates are arranged chronologically in stroke-written order. Specifically, referring to the handwritten character “A”, stroke data item SD1 includes the coordinate data series (time series coordinate) corresponding to each point on the locus of the stroke “Λ”, and the coordinate data series (time series coordinate) are n coordinate data represented as SD11, SD12, . . . SD1n. Stroke data item SD2 includes the coordinate data series (time series coordinate) corresponding to each point on the locus of the stroke “-”, and the coordinate data series (time series coordinate) are n coordinate data represented as SD21, SD22, . . . SD2n. Note that the number of the coordinate data may differ in each stroke data item. Sampling of the coordinate data is performed in a certain cycle while the external object is in contact with the screen, and thus, the number of the coordinate data depends on the length of the stroke.

Each coordinate data indicates coordinates X and Y corresponding to a certain point in the locus. For example, coordinate data SD11 indicates the X-coordinate (X11) and the Y-coordinate (Y11) corresponding to the starting point of the stroke “Λ”. Coordinate data SD1n indicates the X-coordinate (X1n) and the Y-coordinate (Yin) of the finishing point of the stroke “Λ”.

Furthermore, each coordinate data may include timestamp information T corresponding to a point of time when the point corresponding to the coordinate is handwritten. The point of time of the handwriting may be an absolute time (specified by, for example, year, month, date, hour, minute, and second) or a relative time based on a certain standard time. The absolute time (specified by, for example, year, month, date, hour, minute, and second) when the user starts to draw the stroke may be added to each stroke data item as the timestamp information, and in addition, the relative time indicative of a difference between the relative time and the absolute time may be added to each coordinate data in the stroke data item as the timestamp information T.

With the time series information including the coordinate data each having timestamp information T, a time relationship between strokes can be represented accurately. Thus, accuracy in the character recognition of a group including one or more stroke data items defining a single character can be improved.

Furthermore, information (Z) indicative of the pressure of handwriting may be added to each coordinate data. The accuracy in the character recognition of the group can be much improved when the pressure of the handwriting is taken into consideration.

The time series information 200 having the structure as described with reference to FIG. 3 can represent not only the locus of each stroke but also the time relationship between strokes. With the time series information 200, even when the tip of the handwritten symbol “↓” is put near or on the handwritten character “A”, the handwritten character “A” and the tip of the handwritten symbol “↓” can be treated as different character and symbol.

Here, the timestamp information of stroke data SD1 may be, for example, any optional one selected from a plurality of timestamp information items T11 to T1n corresponding to a plurality of coordinates of stroke data SD1 or an average value of the timestamp information items T11 to T1n. Similarly, the timestamp information of stroke data SD2 may be, for example, any optional one selected from a plurality of timestamp information items T21 to T2n corresponding to a plurality of coordinates of stroke data SD2 or an average value of the timestamp information items T21 to T2n. Similarly, the timestamp information of stroke data SD7 may be, for example, any optional one selected from a plurality of timestamp information items T71 to T7n corresponding to a plurality of coordinates of stroke data SD7 or an average value of the timestamp information items T71 to T7n.

As described above, in the time series information 200 of the embodiment, stroke data SD1, SD2, . . . SD7 indicate the stroke order of the handwritten characters. Stroke data SD1 and SD2 indicate that the stroke “Λ” is written initially and the stroke “-” is written later. Thus, even when the two strokes of the handwritten character resemble each other, the two strokes can be distinguished from each other only if the stroke orders of these two strokes are different.

Furthermore, as described above, the handwriting of the embodiment is stored as the time series information 200 formed of a set of a plurality of stroke data corresponding to a plurality of strokes. Thus, the handwriting can be treated without depending on the language of the handwriting. The time series information 200 of the embodiment therefore can be used commonly in various languages spoken in the world.

FIG. 4 illustrates a system structure of the tablet computer 10.

As shown in FIG. 4, the tablet computer 10 includes a CPU 101, system controller 102, main memory 103, graphics controller 104, BIOS-ROM 105, non-volatile memory 106, wireless communication device 107, and embedded controller (EC) 108.

The CPU 101 is a processor configured to control actions of each module in the tablet computer 10. The CPU 101 executes various software programs loaded from the non-volatile memory 106, which is a storage device, to the main memory 103. The software programs include an operating system (OS) 201 and various application programs. The application programs include a handwriting notebook application program 202. The handwriting notebook application program 202 includes a function of preparing and displaying the handwriting page data described above, function of editing the handwriting page data, function of retrieving the handwriting (stroke), and function of recognizing the character, etc.

The CPU 101 executes a basic input output system (BIOS) stored in the BIOS-ROM 105. The BIOS is a program for hardware control.

The system controller 102 is a device to connect a local bus of the CPU 101 to various components. The system controller 102 includes a built-in memory controller configured to control access of the main memory 103. Furthermore, the system controller 102 includes a function to execute a communication with the graphics controller 104 via a serial bus of PCI EXPRESS standard.

The graphics controller 104 is a display controller configured to control an LCD 17A which is used as a display monitor of the tablet computer 10. A display signal generated by the graphics controller 104 is transmitted to the LCD 17A. The LCD 17A displays a screen image based on the display signal. A touchpanel 17B and digitizer 17C are provided on the LCD 17A. The touchpanel 17B is a capacitive pointing device used for an input on the screen of the LCD 17A. When a finger contacts the screen, a point of contact thereof and movement of the point of contact are detected by the touchpanel 17B. The digitizer 17C is an electromagnetic induction pointing device used for an input on the screen of the LCD 17A. When the stylus 100 contacts the screen, a point of contact thereof and movement of the point of contact are detected by the digitizer 17C.

The wireless communication device 107 is configured to execute wireless communication such as a wireless LAN and 3G mobile communication. The EC 108 is a one-chip computer including an embedded controller for power management. The EC 108 is configured to turn on/off the power of the tablet computer 11 in response to a power button operation by the user.

Now, the handwriting notebook application program 202 is described with reference to FIG. 5.

The handwriting notebook application program 202 includes a stylus locus display processor 301, time series information generator 302, edit processor 303, page save processor 304, page acquisition processor 305, handwriting display processor 306, target block selector 307, and processor 308.

The handwriting input application program 202 performs preparation, display, and edit, etc., of handwriting page data by using the stroke data input on the touchscreen display 17. The touchscreen display 17 is configured to detect events such as “touch”, “move (slide)”, and “release” occurring thereon. The event “touch” indicates that an external object has touched the screen. The event “move (slide)” indicates that a point of contact has moved on the screen while the external object is touching thereon. The event “release” indicates that the external object has left the screen.

The stylus locus display processor 301 and the time series information generator 302 receive the event of “touch” or “move (slide)” generated on the touchscreen display 17 to detect the handwriting input operation. The event “touch” includes the coordinate data of the point of contact. In addition, the event “move (slide)” includes the coordinate data of the point of contact after the move. Thus, the stylus locus display processor 301 and the time series information generator 302 receive a coordinate data row corresponding to the locus of the movement of the point of contact from the touchscreen display 17.

The stylus trail display processor 301 receives the coordinate data row from the touchscreen display 17, and based on the coordinate data row, displays, on the screen of the LCD 17A of the touchscreen display 17, loci of the strokes input by the handwriting input operation using the stylus 100 or the like. By the stylus locus display processor 301, the locus drawn by the stylus 100 during the contact on the screen, that is, the locus of each stroke is depicted on the screen of the LCD 17A.

The time series information generator 302 receives the coordinate data row output from the touchscreen display 17, and based on the coordinate data row, generates the time series information specified above with reference to FIG. 3. Here, the time series information, that is, coordinates and timestamp information corresponding to each point in a stroke may be stored in a work memory 401 temporarily.

The page save processor 304 stores the generated time series information in a storage medium 402 as the handwriting page data. The storage medium 402 is a local database configured to store the handwriting page data. The storage medium 402 may be provided inside the server system 2.

The page acquisition processor 305 reads any optional time series information (handwriting page data) stored in the storage medium 402. The read time series information is transmitted to the handwriting display processor 306 and a recognition processor 310. The handwriting display processor 306 analyzes the time series information, and based on a result of the analysis, displays on the screen the strokes (loci) represented by the stroke data in the time series information as a handwritten page.

The edit processor 303 executes a process to edit handwriting (handwritten page) currently being displayed. That is, based on edit operations and handwriting operations performed by the user on the touchscreen display 17, the edit processor 303 executes an edit process to add a new stroke (new handwritten character and symbol, etc.) on the handwritten page currently being displayed and to erase or remove one or more stroke in the strokes currently being displayed. Furthermore, the edit processor 303 updates the time series information to reflect a result of the edit process thereon.

The user uses a tool such as an “eraser” to erase any optional stroke in the displayed strokes. Furthermore, the user uses a tool such as a “range select” to circle or box in any optional portion of the displayed time series information (handwritten page) for selection. Based on the range selected by this range selection operation, a time series information portion to be processed, that is, a stroke data group to be processed is selected by the target block selector 307. In other words, the target block selector 307 uses the displayed time series information to select the time series information portion to be processed from a group of first stroke data corresponding to each of the strokes within the selected range.

For example, the target block selector 307 extracts the group of first stroke data corresponding to each of the strokes within the selected range from the displayed time series information, excludes a second stroke data which is discontinuous with the other stroke data in the group of the first stroke data, and determines each stroke data left in the group of the first stroke data as the time series information portion to be processed.

The edit processor 303 performs processes such as deletion or removal of the stroke data group selected by the target block selector 307 when the user selects “delete” or “move” in the edit menu. Therein, when a plurality of stroke data are selected as the stroke data group to be processed, the edit processor 303 can delete the plurality of stroke data altogether or remove them to the other position on the screen. In this removal, the time series coordinate of each stroke data may be adjusted automatically in accordance with the relocated position. An operation history indicative of the adjustment of the time series coordinate may be added to the time series information. Even when the stroke data is deleted, it is not necessarily deleted from the time series coordinate, and only an operation history indicative of the deletion of the stroke data may be added to the time series information.

Considering a case where a user wishes to edit his handwriting which has already been input, the handwriting may be, as described above, deleted and an edited handwriting is then input again. On the other hand, considering a case where a user wishes to edit his handwriting written down on a paper, such an erroneous handwriting may not necessarily be erased but an edited handwriting is simply overwritten on the erroneous handwriting. The embodiment corresponds to such an overwritten edition (without deleting or erasing a character) and performs the character recognition process suitably. When two strokes are written overlapping, a human eye can easily distinguish between edited one and erroneous one. However, a character recognition processor cannot recognize an edited one if the two strokes are overlapping with each other. To deal with this problem, the embodiment recognizes an overlapping state of two strokes, estimates the user's intention, validates one of the two strokes, and invalidates the other one for the character recognition process.

The processor 308 executes various processes such as a handwriting retrieval process, a character recognition process, and the like with respect to the time series information to be processed. The processor 308 includes a retrieval processor 309 and a recognition processor 310.

The retrieval processor 309 retrieves a plurality of time series information (a plurality of handwritten pages) which have already been stored in the storage medium 402 and finds out a specific time series information portion (specific handwritten character string, etc.) therefrom. The retrieval processor 309 includes a designation module configured to designate the specific time series information portion as a retrieval key, i.e., a retrieval query. The retrieval processor 309 finds out the time series information portion including a stroke locus whose similarity to a stroke locus corresponding to the specific time series information portion is more than a criterion, reads the handwriting page data including the found time series information portion from the storage medium 402, and displays the handwriting page data on the screen of the LCD 17A in such a manner that the locus corresponding to the found time series information portion can be acknowledged visually.

As the time series information portion designated as the retrieval key may be a specific handwritten character, specific handwritten character string, specific handwritten symbol, or specific handwritten figure, etc. For example, one or more strokes of a handwritten object (handwritten character, handwritten symbol, or handwritten figure) written on the touchscreen display 17 can be used as the retrieval key.

The retrieval process executed by the retrieval processor 309 is a handwriting retrieval process. Therein, the handwritten character string including handwriting which resembles the specific handwritten character string regarded as the retrieval key is retrieved from a plurality of handwritten pages already stored. Note that the handwriting retrieval may be performed targeting a particular handwritten page currently being displayed.

The retrieval processor 309 retrieves a handwritten page including a stroke which resembles a feature of one or more stroke regarded as the retrieval key from the storage medium 402. The feature of each stroke is, for example, a shape, writing direction, and slant of the stroke. From the storage medium 402, the handwriting page data (hit handwritten page) including a handwritten character whose similarity to a stroke of the handwritten character regarded as the retrieval key is more than a criterion is retrieved. To calculate the similarity between the handwritten characters, various methods can be used. For example, a coordinate string of each stroke may be used as a vector. In that case, a similarity between vectors to be compared may be calculated as an inner product of the vectors to be compared. Or, handling a locus of each stroke as an image, images of loci to be compared are overlapped and a largest area of the overlapping portion of the locus images may be calculated as the similarity. To reduce a load in calculation process, any optional improvement should be taken. A dynamic programming (DP) matching may be used as a method for calculating the similarity between handwritten characters.

As can be understood from the above, the stroke data is used as the retrieval key instead of codes indicative of a character string, and thus, the retrieval process is performed without depending on languages.

Note that the retrieval process is performable targeting not only the handwriting page data group in the storage medium 402 but also the handwritten page data group stored in the storage medium of the server system 2. In that case, the retrieval processor 309 transmits a retrieval request including one or more stroke data corresponding to one or more stroke to be used as the retrieval key to the server system 2. The sever system 2 retrieves the handwriting page data (hit handwritten page) including a feature which resembles the feature of the one or more stroke data from the storage medium 402 and transmits the hit handwritten page to the tablet computer 10.

The designation module in the retrieval processor 309 may display on a screen a retrieval key input region to receive handwriting of a character string or a figure to be retrieved. The character string and the like handwritten on the retrieval key input region by the user is used as the retrieval query.

Otherwise, the target block selector 307 may be used as the designation module. In that case, based on the range selection operation by the user, the target block selector 307 can select the specific time series information portion in the time series information currently being displayed as a character string or figure to be retrieved. The user then may surround a part of the character string in the page currently being displayed to select a range, or may handwrites a new character string as the retrieval query at a blank of the page currently being displayed and surrounds the newly-written character string as the retrieval query to select a range.

For example, the user may select a range by circling a part of the page currently being displayed in handwriting. Or, the user may open a pre-arranged menu to set the handwriting notebook application program 202 to a “select” mode, and then trace the part of the page currently being displayed with the stylus 100.

As can be understood from the above, in the embodiment, a handwritten character which resembles a feature of a certain handwritten character selected as a retrieval query from a plurality of handwritten pages which have already been recorded. Thereby, a handwritten page the user seeks can easily be retrieved from a number of pages prepared and stored in the past.

In the handwriting retrieval of the embodiment, a character recognition process is not necessary unlike a text retrieval process. Therefore, the handwriting retrieval of the embodiment is not limited by languages, and an object to be retrieved is a handwritten page written in any language. Furthermore, a figure, diagram, and the like can be used as a retrieval query for the handwriting retrieval, and moreover, a symbol, mark, or the like can be used as the retrieval query for the handwriting retrieval.

The recognition processor 310 executes the character recognition with respect to the time series information (handwritten page) currently being displayed. The recognition processor 310 matches one or more stroke data (stroke data group) corresponding to the character, numeral, and symbol, etc., to be recognized with dictionary stroke data (stroke data group) of each character, numeral, and symbol, etc., and converts each of the handwritten character, numeral, and symbol, etc., into a character code. The dictionary stroke data may be any information indicative of a relationship between each character, numeral, and symbol, etc., and one or more stroke data, and specifically, identification information of each character, numeral, and symbol, etc., and one or more stroke data corresponding to the identification information are used as the dictionary stroke data. In this group matching process, one or more stroke data indicated by the time series information to be recognized are grouped to classify stroke data each corresponding to strokes handwritten closely and continuously in the same block. Note that, in addition to the handwriting (bitmap image), the time series information includes the stroke order, timestamp information, and handwriting pressure information in some instances, and thus, the accuracy of recognition can be improved with this information.

Through the above process, a character code of a group corresponding to each character can be obtained from the time series information. When the character codes are aligned based on the arrangement of the group, a text data of handwriting page data of a single page can be obtained. Then, both character code and text data are related with each other and stored in the storage medium 402.

Hereinafter, a specific example of the embodiment is described. Now, described is an example of a procedure of a handwritten page preparation process executed by the handwriting notebook application program 202 referring to a flowchart shown in FIG. 6.

When the user uses the stylus 100 to perform a handwriting input operation (block 102), the events such as “touch” and “move” occur accordingly. Based on these events, the handwriting notebook application program 202 detects a locus of the movement of the stylus 100 (block 104). When the locus of the stylus 100 is detected (YES in block 104), the handwriting notebook application program 202 displays the locus of the detected movement of the stylus 100 (block 106). Furthermore, the handwriting notebook application program 202 generates the aforementioned time series information as shown in FIG. 3 based on the coordinate string corresponding to the locus of the detected movement of the stylus 100, and temporarily stores the time series information in the work memory 401 as handwritten page information (block 108).

The user sees the displayed locus and, if he considers an edition of the handwritten character necessary, adds a necessary edition by overwriting (block 110). As a matter of course, an edited character can be input after erasing the character to be edited by an eraser function. However, such an edition method is a publically-known technique and its explanation is omitted. Concerning the embodiment, a method for editing a stroke data by overwriting is explained. When the overwrite is added on the handwriting in block 110, the time series information includes a plurality of strokes overlapped with each other, and the character recognition cannot be performed in such a state.

In block 112, the handwriting notebook application program 202 determines whether or not an instruction to start the character recognition is made. For example, when a recognition button in the menu displayed at an edge of the screen of the LCD 17A is touched, it is acknowledged as the instruction to start the character recognition. A preprocessing is performed in block 114 and the character recognition process is performed in block 116. The preprocessing is performed to determine which of the plurality of strokes overlapping with each other is valid and also determine that the other strokes are invalid. Thereby, the overlapping state is solved and the strokes can be used in the character recognition process.

FIG. 7 shows an example of the preprocessing (block 114) and the character recognition (block 116) shown in FIG. 6.

In block 132, whether or not an overlap of strokes (even a partial overlapping) exists is determined. Note that the determination may not be performed after the instruction to start the character recognition is given but may be performed in the background during the handwriting input operation. The overlap of strokes can be detected by determining whether or not the same coordinate data is in two stroke data, that is, whether or not the same point is included in the loci of the two strokes. Here, the determination is actually performed by determining whether or not the coordinate data of the two strokes are in a certain permissible range, thus, the coordinate data of the two strokes are not necessarily in exactly the same position.

When there are the two strokes overlapping with each other even partially, an overlapping state is then identified. In the embodiment, overlapping states are divided into the following three states: an inclusion state, connection state, and repeatedly overlapping state, and one of these three states is identified.

Firstly, whether or not the two strokes are in the inclusion state (a state where at least a part of one stroke includes a part of the other completely) is determined in block 134.

FIGS. 8A to 8D indicate examples of the inclusion state. FIGS. 8A and 8B indicate that “5” is handwritten and then “6” is overwritten thereon. A part of the stroke writing “6” overlaps a part of the stroke writing “5,” and thus, the stroke of “6” (inclusion stroke) includes the stroke of “5” (included stroke).

FIGS. 8C and 8D indicate that “i” is handwritten and then “l” is overwritten thereon. A part of the stroke writing “l” overlaps a part of the stroke writing “i,” and thus, the stroke of “l” (inclusion stroke) includes the stroke of “i” (included stroke).

To determine the inclusion state, circles whose centers are points of coordinate data of one of the strokes are drawn initially. Then, a region surrounded by tangent lines and arcs of adjacent two circles is defined per point. If the regions completely include the other stroke, then it is the inclusion state. As shown in FIGS. 9A and 9B, when there are two strokes whose coordinates y are substantially at the same position but their lengths are different, a region surrounded by the tangent lines and arcs of three circles regarding to the three coordinate data does not completely include the long stroke of FIG. 9B, as shown in FIG. 9C. Thus, it is determined that the stroke of FIG. 9A does not include the stroke of FIG. 9B. On the other hand, a region surrounded by the tangent lines and arcs of the five circles regarding to the five coordinate data includes the short stroke of FIG. 9A completely, as shown in FIG. 9D. Thus, it is determined that the stroke of FIG. 9B includes the stroke of FIG. 9A. This method is, however, an example of many other methods to determine the inclusion state, and can be replaced with any other optional method adoptable to estimate that one stroke substantially includes the other stroke.

Whether or not the inclusion stroke is written after the included stroke is determined in block 136. In the examples of FIGS. 8A to 8D, the inclusion stroke is written after the included stroke, and thus, it can be determined that the user wished to cancel the included stroke and overwrote the inclusion stroke for edition. However, there may be a case where the included stroke of FIG. 9A is overwritten after the inclusion stroke of FIG. 9B to edit the inclusion stroke by the included stroke.

To deal with such a case, when the inclusion stroke is written after the included stroke (as in examples of FIGS. 8A to 8D), the included stroke is determined to be invalid and the inclusion stroke is determined to be valid in block 138. On the other hand, when the inclusion stroke is written before the included stroke (as in examples of FIGS. 9A to 9D), the inclusion stroke is determined to be invalid and the included stroke is determined to be valid in block 140. Thus, when two strokes are in an inclusion state, only one stroke which suits for the user's intention becomes valid and the other stroke becomes invalid, and handwriting can be edited by overwriting. Since only the valid stroke is applied to the character recognition process and the invalid stroke is disregarded, the recognition results in accordance with the user's intention.

When the inclusion state is not detected in block 134, whether or not the stroke overlapping the other (the latter-written stroke) is a repeated stroke is determined in block 142. Therein, specifically, whether or not the stroke overlapping the other is a stroke returning to a start region is determined.

FIGS. 10A to 10C show an example of a stroke returning to a starting point. When a user wishes to edit “2009” in FIG. 10A to “2010,” the user may write a single stroke drawn up and down for many times to put “1” upon “0” as shown in FIG. 10B, and may write a single stroke repeated round and round for many times to put “0” upon “9.” In both cases of writing “1” in the single up and down stroke and writing “0” in the single repeated stroke, the stroke returns in proximity to its starting point. Therefore, from the time series coordinates SDij of the stroke data SDi, whether or not there is one in proximity to the time series information DSi1 which is the start point of the stroke is determined.

If the stroke returns to its starting point, whether the stroke is reciprocated (that is, “1” of FIG. 10B) or not (that is, “0” of FIG. 10B) is determined in block 144. The reciprocation can be determined based on a direction of the locus reversed during the stroke writing. When the vector direction between the time series coordinates (points) included in the stroke data is reversed, it is determined that the stroke is reciprocated. When the reciprocated locus is acknowledged, the original stroke is determined to be invalid and the average length of a plurality of downward strokes or the longest stroke is determined to be valid in block 146. When the reciprocated locus is not acknowledged (when the repeated locus is acknowledged), the original stroke is determined to be invalid and the average area of a plurality of repeated strokes or the largest stroke is determined to be valid in block 148. Thereby, “2009” is changed to “2010” as shown in FIG. 100.

Note that, in such a case where “S” is written on “l,” a dollar sign “$” appears, and when “S” is written only once, it is not determined to be an overwrite and is regarded as “$.” However, when “S” is repeated, it is determined that the user wishes to change “l” to “S,” and as shown in block 148, “l” is determined to be invalid and “S” is determined to be a valid stroke.

When the repeated stroke is not detected in block 142, and after blocks 146 and 148, whether or not the overlapping state of the two strokes is a connection state is determined in block 150.

FIGS. 11A to 11E show an example of a connection state. As shown in FIGS. 11A and 11B, after “2” is handwritten, the below half of “3” is attached to the lower end of “2” to write “3” as shown in FIG. 11E. To determine such a connection state, circles whose centers are points of coordinate data of one of the strokes are drawn. Then, a region surrounded by tangent lines and arcs of adjacent two circles is defined per point. Furthermore, circles whose centers are points of coordinate data of the other stroke are drawn. Then, a region surrounded by tangent lines and arcs of adjacent two circles is defined per point. Seeing if the region partially includes the other stroke (as shown in FIGS. 11C and 11D), the connection state is determined. When the region defined based on the other stroke partially includes the other stroke, it is a connection state. That is, as shown in FIGS. 11C and 11D, the lowermost line segment of “2” and the uppermost line segment of the below half of “3” include each other, and thus, the middle part of “3” shown in FIG. 11B is determined to be in the connection state. Otherwise, a distance between a certain point of a first stroke and each point of second stroke is calculated, and a distance between the point closest to the certain point of the first stroke and each point of the first stroke is calculated, and then, if their average value is within a threshold value, the first and second strokes are determined to be in the connection state. This method is, however, an example of many other methods to determine the connection state, and can be replaced with any other optional method adoptable to estimate that one stroke substantially connects to the other stroke.

When the connection state is acknowledged, the two strokes are connected to each other in block 152, and the original stroke becomes invalid and the new stroke obtained from the connection becomes valid.

As can be understood from the above, even when the user overwrites the other stroke on the originally input stroke, a valid stroke to be subjected to the character recognition process can be estimated considering both original and overwritten strokes. Conventionally, when handwriting is input to a device such as digital notebook, etc., an erroneous part is canceled by an eraser to input an edited character for proper character recognition. However, in the embodiment, the new stroke overwritten on the original stroke can be subjected to the proper character recognition.

The stroke determined to be invalid by the overwriting is canceled and the stroke determined to be valid is displayed instead in block 156.

The stroke displayed in block 156 is subjected to the character recognition process in block 158. The stroke data of the time series information in block 158 is divided into groups each of which includes stroke data corresponding to the strokes handwritten continuously and close to each other. One group corresponds to one symbol and includes one or more stroke data. In the example of FIG. 3, stroke data SD1 and SD2 correspond to one group, stroke data SD3 and SD4 correspond to one group, and stroke data 5 corresponds to one group. One or more stroke data (stroke data group) corresponding to the character, numeral, and symbol to be subjected to the recognition process are matched with the dictionary stroke data (stroke data group) of each character, numeral, and symbol to convert the character, numeral, and symbol, etc., into character codes. Then, a language processing is performed to determine a character string which appears to be accurate as a language. For example, if a word “ [symbol] (nakisuto)” is a candidate, the first character “ [symbol] (na)” is changed to “ [symbol] (te)” so that a result of recognition can be a word “ [symbol] (tekisuto: text in English)”. Thereby, the time series information of the text input by a handwriting and the character code string (“ [symbol] (tekisuto)”) can be acquired. The result of recognition: “ [symbol] (tekisuto)” is displayed in block 158. Further, if a word “9ood” is a candidate, the first character “9” is changed to “g” so that a result of recognition can be a word “good.”

The user sees the result of recognition in block 160 and terminates the process if the result of recognition is a desired one. If it is not, the user again performs the overwrite operation in block 162 and returns to block 134.

According to the embodiment, when the two strokes are overlapping each other, the state of the overlapping is identified to estimate the user's intention, and a certain stroke is determined to be valid while the other stroke is determined to be invalid before performing the character recognition process. Therefore, it is not necessary to cancel a character to input an edited character for the edition of the handwriting, and an edited character is simply overwritten on an erroneous character. Even in such an overwritten edition, the character recognition process can be performed suitably.

In the above description, the embodiment has been explained given that the character recognition is performed; however, the character recognition is not essential and the embodiment can be applied to a case where a handwritten character is edited by an overwrite process. That is, the embodiment may be performed until the display of the overwritten stroke in block 156 of FIG. 7 and the character recognition process may be omitted. Furthermore, even when the character recognition is performed, the overwrite process may be performed as not only a preprocessing before the recognition but also a post-processing after the recognition. That is, as the post-processing after the character recognition, a part where a desired result of recognition is not obtained or an erroneous part of the handwriting to be edited may be edited by the overwriting on the handwritten character display screen.

The entire processes of the embodiment have been performed in the tablet computer 10; however, the processes other than the handwriting input on the touchscreen display 17 may be performed at the server system 2. For example, the functions of the processor 308 of the handwriting notebook application may be transferred to the server system 2. Moreover, the database of the server system 2 may be used for storage instead of the storage medium 402.

The various modules of the systems described herein can be implemented as software applications, hardware and/or software modules, or components on one or more computers, such as servers. While the various modules are illustrated separately, they may share some or all of the same underlying logic or code.

Moreover, the processes of the embodiment can be achieved by a computer program. When such a computer program is installed into a computer through a computer readable storage medium storing such a computer program and executed, the same advantage obtained in the embodiment described above can be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
an input controller configured to receive first stroke data corresponding to a first stroke and to receive second stroke data corresponding to a second stroke after the first stroke data; and
a processor configured to, if the first stroke and the second stroke at least partially overlap with each other, edit the first stroke data by using the second stroke data.

2. The electronic device of claim 1, further comprising a recognition result display controller configured to, when the first stroke data is edited by the processor, display a character recognition result based on the edited stroke data.

3. The electronic device of claim 2, wherein the recognition result display controller displays the character recognition result based on the second stroke data, not on the first stroke data.

4. The electronic device of claim 3, wherein the recognition result display controller displays the character recognition result based on a third stroke data obtained by connecting the first stroke and the second stroke.

5. The electronic device of claim 1, further comprising a stroke display controller configured to display a first locus corresponding to the stroke data received by the input controller, and wherein the stroke display controller is configured to, when the processor edits the first stroke data, display a second locus corresponding to the edited stroke data.

6. An information processing method, comprising:
receiving by an electronic device stroke data; and
editing, if first stroke data and second stroke data received after the first stroke data at least partially overlap with each other, the first stroke data by using the second stroke data.

7. A non-transitory computer-readable storage medium having stored thereon a computer program which is executable by a computer, the computer program comprising instructions capable of causing the computer to execute functions of:
receiving a stroke data; and
editing, if first stroke data and second stroke data received after the first stroke data at least partially overlap with each other, the first stroke data by using the second stroke data.
